(19) United States
(12) Patent Application Publication
(10) Pub. No.: US 2026/0318468 A1
(43) Pub. Date: Oct. 15, 2026

(54) MOUNTABLE AND STOWABLE PERSONAL ELECTRONIC DEVICE HOLDER

(71) Applicant: B/E Aerospace, Inc., Winston-Salem, NC (US)

(72) Inventors: Ayyappan Prasanna Kumar, Hyderabad (IN); Bharathkannan R, Coimbatore (IN); Gerry J. Overhiser, Winston-Salem, NC (US)

(21) Appl. No.: 19/643,325

(22) Filed: Apr. 9, 2026

(30) Foreign Application Priority Data
Apr. 11, 2025 (IN) 202511035624

(51) Int. Cl. F16M 11/08; F16M 11/04

(52) U.S. Cl. CPC F16M 11/08; F16M 11/041

(57) ABSTRACT

A portable electronic device (PED) holder for mounting in a support surface. In embodiments, the PED holder includes a rotation limiter mountable to the support surface, a base rotatably mounted in the rotation limiter and rotatable about a vertical axis, a bezel mounted in the base, and a disc rotatably mounted in the base, the disc rotatable about a horizontal axis, and the disc having a first side that is substantially planar and a second side including a PED holding feature. In use, the disc is configured to rotate between a stowed state in which the first side of the disc is positioned atop the PED holder, and a deployed state in which the second side of the disc is positioned atop the PED holder.

### CROSS REFERENCE TO RELATED APPLICATION

This application claims the benefit of priority of Indian Provisional Application No. 202511035624 filed Apr. 11, 2025, which is hereby incorporated by reference in its entirety.

### TECHNICAL FIELD AND BACKGROUND

The present disclosure relates generally to passenger amenities, and more particularly, to a mountable and stowable PED holder for aircraft and other conveyances.

PEDs such as tablets and smartphones are commonly used on aircraft. In economy seating classes, PED holders are typically integrated into the seat back of a forward seat. In premium seating classes, novel mounting solutions are needed due to the absence of a nearby forward seat. In aircraft, passenger amenities such as PEDs used during flight may be required to stow in preparation for taxi, takeoff, and landing (TTOL). In addition, it is desirable for aircraft amenities such as PED holders to be adaptable to various mounting locations, consume a minimal amount of space, be intuitive to operate, and have a low profile when stowed.

Therefore, what is needed is a mountable and stowable PED holder solution for premium class seating applications.

### BRIEF SUMMARY

According to one aspect, the inventive concepts according to the present disclosure are directed to a portable electronic device (PED) holder including a rotation limiter mountable to a support surface, a base rotatably mounted in the rotation limiter and rotatable about a vertical axis, a bezel mounted in the base, and a disc rotatably mounted in the base, the disc rotatable about a horizontal axis, and the disc having a first side that is substantially planar and a second side including a PED holding feature. In use, the disc is configured to rotate between a stowed state in which the first side of the disc is positioned atop the PED holder, and a deployed state in which the second side of the disc is positioned atop the PED holder.

In some embodiments, the PED holder further includes a tab mounted to the disc, a latch mounted to the tab, and a catch mounted to the base, wherein the tab is configured to interface with the base to maintain the disc in the deployed state, and the latch is configured to interface with the catch to maintain the disc in the stowed state.

In some embodiments, the base has an opening through a side and bottom of the base, and the tab travels within the opening as the disc rotates between the stowed and deployed states of the disc.

In some embodiments, the disc is rotatably mounted to the base by a pair of hinge clamp and friction hinge subassemblies.

In some embodiments, the rotation limiter has a circumferential opening, the base has a laterally extending portion disposed in the circumferential opening, and the base interfaces with the rotation limiter to constrain rotational motion of the base.

In some embodiments, the PED holding feature is a groove formed between two upstanding walls.

In some embodiments, the PED holder further includes at least one nylon spacer disposed at the interface between the base and the rotation limiter.

In some embodiments, the PED holder further includes a closeout configured to cover an opening formed between the disc and the bezel when the disc is in the deployed state.

According to another aspect, the inventive concepts according to the present disclosure are directed to a PED holder including a round rotation limiter mountable to a support surface, a round base rotatably mounted in the rotation limiter and rotatable about a vertical axis, and a round disc rotatably mounted in the round base, the round disc rotatable about a horizontal axis, and the round disc having a first side that is substantially planar and a second side including a PED holding feature. In use, the round disc is configured to rotate between a stowed state in which the first side of the round disc is positioned atop the PED holder, and a deployed state in which the second side of the round disc is positioned atop the PED holder.

According to a further aspect, the inventive concepts according to the present disclosure are directed to an assembly including a support surface having a through opening, and a PED holder disposed in the through opening and mounted to the support surface. In embodiments, the PED holder includes a rotation limiter mountable to the support surface, a base rotatably mounted in the rotation limiter and rotatable about a vertical axis, a bezel mounted in the base, and a disc rotatably mounted in the base, the disc rotatable about a horizontal axis, and the disc having a first side that is substantially planar and a second side including a PED holding feature. In use, the disc is configured to rotate between a stowed state in which the first side of the disc is positioned atop the PED holder substantially flush with the support surface, and a deployed state in which the second side of the disc is positioned atop the PED holder and extends above the support surface.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is an isometric view of a PED holder shown in a deployed state, in accordance with example embodiments of this disclosure;

FIG. 2 is an isometric view of the PED holder shown in a stowed state, in accordance with example embodiments of this disclosure;

FIG. 3 is an isometric view of the PED holder shown in a deployed state holding a tablet, in accordance with example embodiments of this disclosure;

FIG. 4A is a perspective view of the PED holder shown in a deployed state holding a smartphone at a first viewing angle, in accordance with example embodiments of this disclosure;

FIG. 4B is a perspective view of the PED holder shown in a deployed state holding a smartphone at a second viewing angle, in accordance with example embodiments of this disclosure;

FIG. 4C is a perspective view of the PED holder shown in a deployed state holding a smartphone at a third viewing angle, in accordance with example embodiments of this disclosure;

FIG. 5 is an exploded view of the PED holder, in accordance with example embodiments of this disclosure;

FIG. 6 is a longitudinal cross-section of the PED holder shown in the deployed state, in accordance with example embodiments of this disclosure; and

FIG. 7 is a longitudinal cross-section of the PED holder shown in the stowed state, in accordance with example embodiments of this disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to a PED holder mountable in a support surface, and an assembly including a through opening and PED holder mounted in the through opening. In embodiments, the support surface may be a table, shelf, armrest, console, tray table, or any other furniture. In embodiments, the support surface may be disposed proximal to a seat such that the PED holder is usable by a seat occupant during travel. In an aircraft application, the PED holder is configured to transition between a stowed state in preparation for TTOL and a deployed state for use during flight.

Features, benefits, and advantages of the PED holder according to the present disclosure include, but are not limited to, practical equipment to hold a PED or other item (e.g., book) hands free at an ergonomic and adjustable viewing angle, minimal space requirement, simple and intuitive operation, practically invisible when in the stowed state, can be integrated into various furniture and cabin configurations, smooth operation, multi-directional adjustment, no pinch point issues, no trash trap/spillage issues, lightweight, and robust operation.

In a particular conceived example, the support surface (e.g., shelf or console) may be positioned alongside a seat, and the PED holder may be mounted in a through hole in the support surface. In use, the PED holder includes a disc that is manipulated by hand to rotate the disc about a horizontal axis between a stowed state and a deployed state. When deployed, the disc may be manipulated by hand to rotate the disc about a vertical axis to adjust the viewing angle. In embodiments, the viewing angle may have an angular range of adjustment of about 90 degrees, more preferably about 45 degrees, and even more preferably about 20 degrees, although other angular ranges are envisioned. In a particular conceived example, the depth of the PED holder may be about 2.5 inches (i.e., about 6.4 cm), and the diameter of the PED holder may be about 3.5 inches (i.e., about 9.0 cm), although other depths and diameters are envisioned.

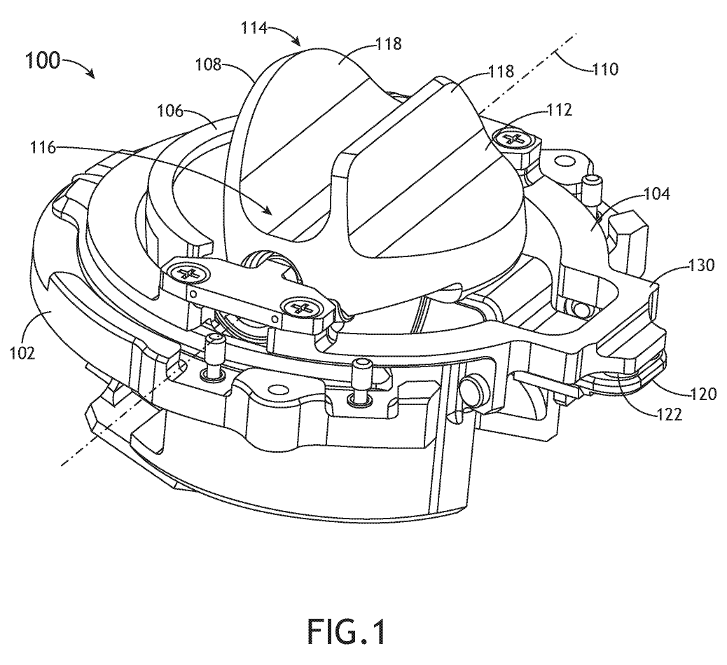

FIG. 1 depicts the PED holder 100 in a deployed state. In an aircraft application, the deployed state may correspond to a phase of flight other than in preparation for TTOL, for instance parked at the gate or in flight. In embodiments, the PED holder 100 generally includes a rotation limiter 102 mountable to a support surface, a base 104 rotatably mounted in the rotation limiter 102, a bezel 106 mounted in the base 104, and a disc 108 rotatably mounted in the base 104. In embodiments, the disc 108 is rotatable about a horizontal axis 110 and includes a second side 112 having a PED holding feature 114. In embodiments, the PED holding feature 114 may be a groove 116 formed between two upstanding walls 118. In embodiments, the upstanding walls 118 may be parallel and may be vertical or oriented near vertical. When in the deployed state, the second side 112 of the disc 108 is positioned atop the PED holder such that the PED holding feature is available for use is holding a PED such as a tablet or smartphone.

In embodiments, the PED holder 100 further includes a tab 120, for instance an elongated tab, mounted to the disc 108 such that the tab moves with the disc 108 as the disc 108 rotates between the stowed and deployed states. In the deployed state shown in FIG. 1, the tab 120 interface with the base 104 to limit rotation of the disc 108. In other words, in use, the disc 108 can be rotated until the tab 120 interacts with (e.g., engages) the base to stop further rotation of the disc 108 in the deployment direction. When fully deployed as shown in FIG. 1, the second side 112 of the disc 108 is positioned atop the PED holder 100 such that the PED holding feature 114 is available for use. In embodiments, one or more bumpers 122 may be affixed to the tab 120 to engage the base 104.

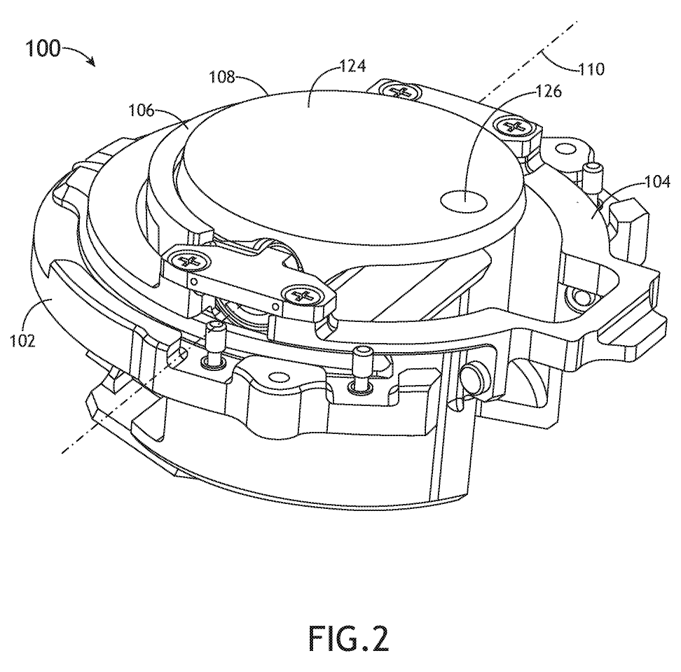

FIG. 2 depicts the PED holder 100 in a stowed state. In embodiments, the disc 108 includes a first side 124 positioned atop the PED holder 100 when the disc 108 is fully stowed. In embodiments, the first side may be planar or substantially planar to provide a low profile for the PED holder when fully stowed. In embodiments, the first side 124 may include a depression 126 indicating the local to push-to-deploy the disc 108 to expose the second side 112. Depressing the disc 108 causes rotation around the horizontal axis 110. When fully stowed as shown in FIG. 2, the tab is disengaged from the base 104 as described in detail below. The bezel 106 serves to provide a clean finish to the look of the PED holder 100, for instance a concentric ring arrangement.

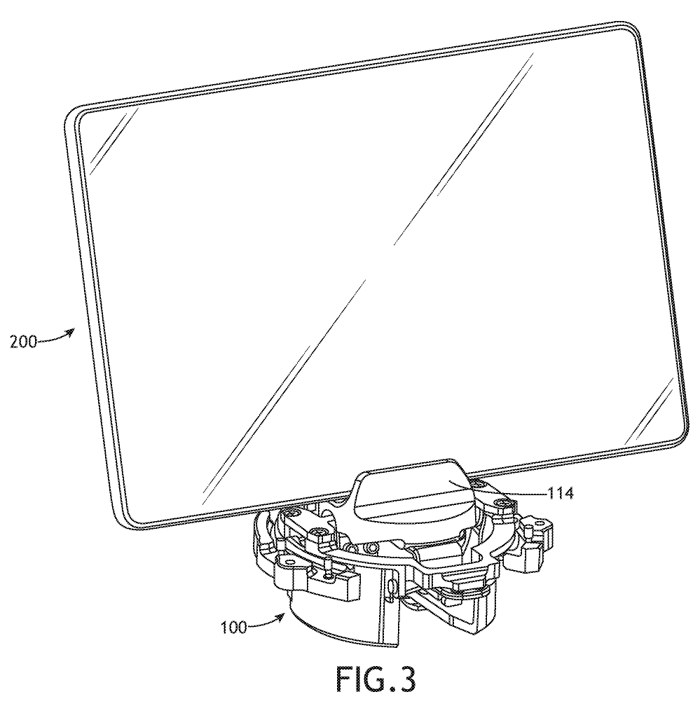

FIG. 3 depicts the PED holder 100 in the deployed state holding a PED 200, for instance a tablet computer. Although the tablet computer 200 is shown in a landscape orientation, the PED holding feature 114 (e.g., implemented as a groove formed between upstanding walls) can also hold the tablet computer 200 in a portrait orientation. In embodiments, the upstanding walls may be spaced a predefined distance to accommodate various device thicknesses, and in some embodiments, allow the device to be held in a tilted orientation for a desirable viewing angle.

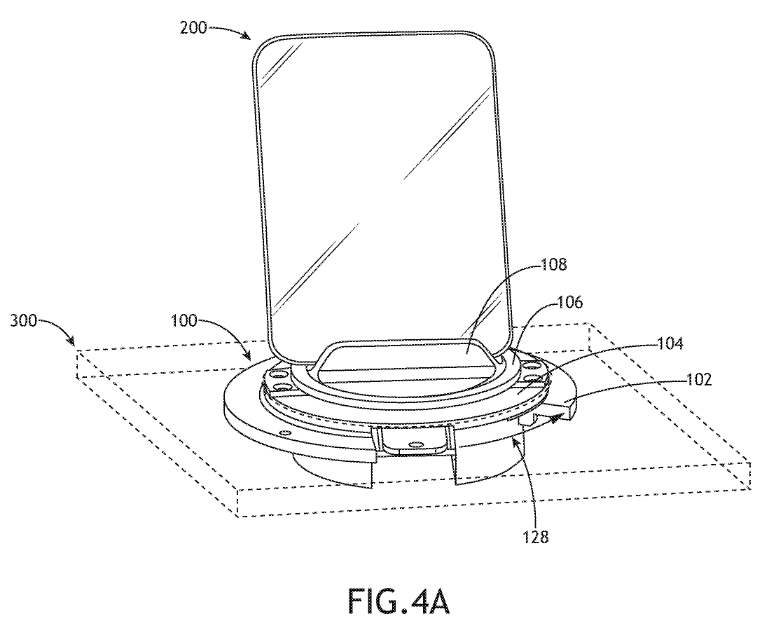

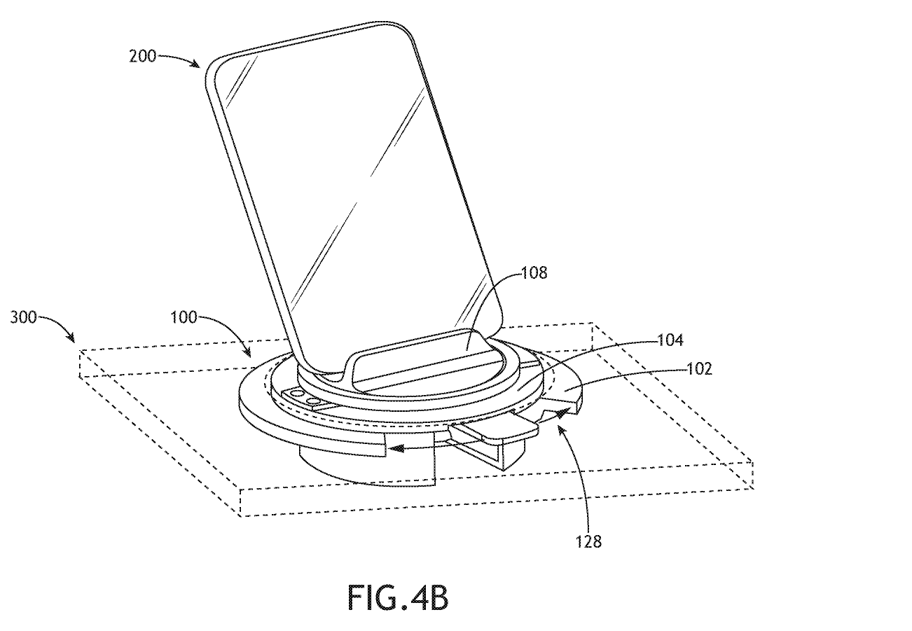

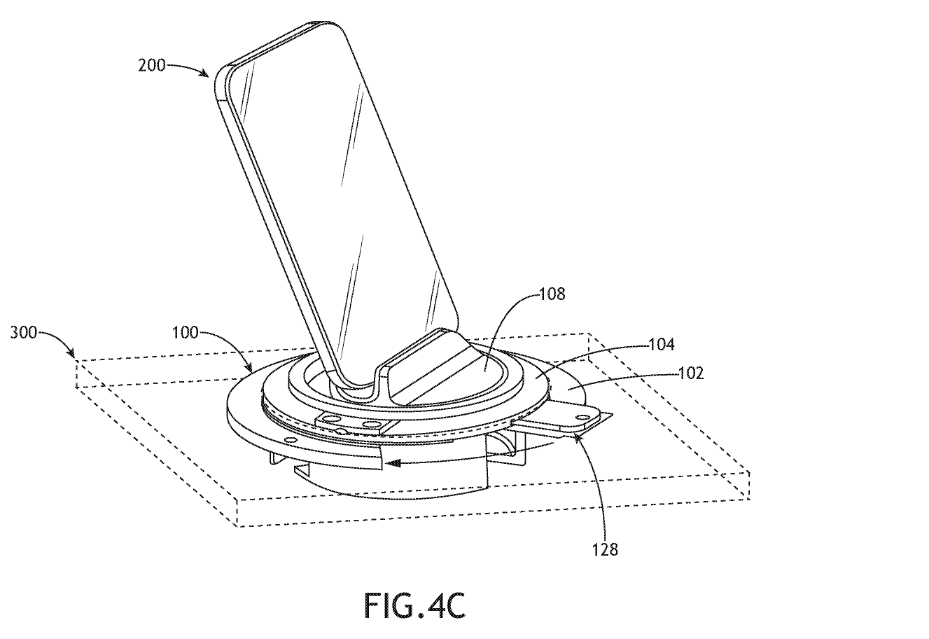

FIGS. 4A-4C depict the PED holder 100 mounted in a support surface 300 and holding a PED 200, for instance a smartphone. In embodiments, the support surface 300 may be a table, shelf, seat components, etc., having a through hole for mounting the PED holder 100. In embodiments, the majority of the PED holder 100 may be disposed within or below the top of the support surface 300 such that, from above, the bezel 106 and the disc 108 are visible to the user, and in some embodiments, positioned substantially flush with the top of the support surface 300. In this configuration, the PED holder 100 has a low profile to substantially hide from view when in the stowed state.

FIG. 4A depicts the PED holder 100 in the deployed state and in use, and with the base 104 rotated to a ‘leftmost’ position to position the PED 200 at a first viewing angle. FIG. 4B depicts the PED holder 100 in the deployed state and in use, and with the base 104 rotated to a ‘centered’ position to position the PED 200 at a second viewing angle. FIG. 4C depicts the PED holder 100 in the deployed state and in use, and with the base 104 rotated to a ‘rightmost’ position to position the PED 200 at a third viewing angle. In embodiments, the degree of rotation between the fully ‘leftmost’ and fully ‘rightmost’ may determined by a length of a circumferential opening 128 provided in the rotation limiter 102. In embodiments, the base 104 has a laterally extending portion (see FIG. 1 at 130) that extends into the circumferential opening 128. In use, the laterally extending portion 130 rotates steplessly within the circumferential opening 128, and interfaces with the rotation limiter 102 which acts as a mechanical stop against further rotation in each direction.

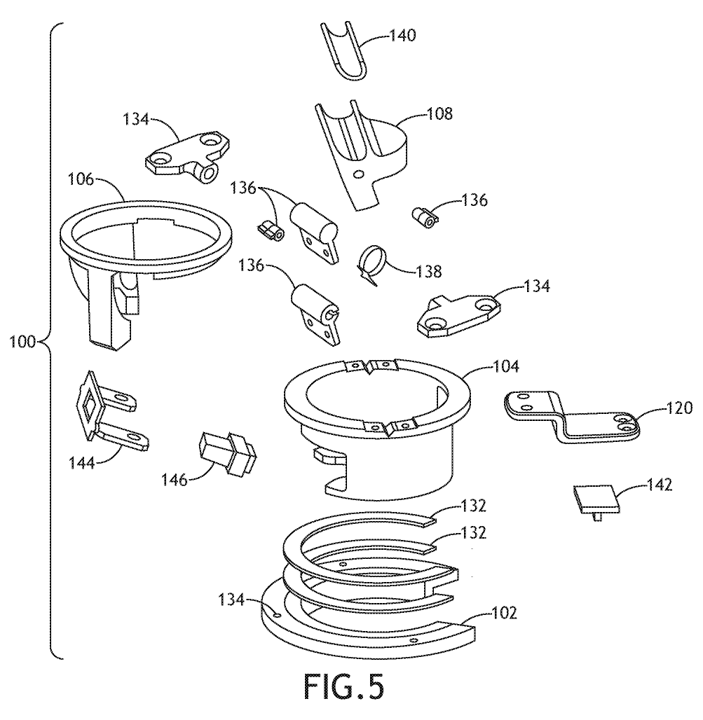

FIG. 5 depicts a disassembled state of the PED holder 100 to show the basic components. In embodiments, the rotation limiter 102 may be round or C-shaped to constrain rotation of the base 104 rotatably mounted in the rotation limiter 102. In embodiments, the rotation limiter 102 may include one or more through holes 134 for receiving one or more fasteners to mount the rotation limiter 102 to the support surface, for instance from below. In some embodiments, one or more nylon spacers 132 may be disposed at the interface between the base 104 and the rotation limiter 102 to facilitate smooth motion.

In embodiments, the bezel 106 mounts in the base 104 and the disc 108 rotatable mounts to the base 104. In embodiments, the disc 108 mounts to the base by a pair of subassemblies including a hinge clamp 134 and friction hinge 136. In the case of round components (e.g., rotation limiter 102, base 104, bezel 106, disc 108), the subassemblies may be diametrically opposed on the base 104 and attach by fasteners. In some embodiments, a spring subassembly 138 may bias the disc 108 toward the stowed state. In some embodiments, a pad 140, for instance a silicon rubber pad, may be seated in the groove formed in the disc 108.

In embodiments, the tab 120 mounts to the disc 108 and may be elongated such that the tab 120 extends with, or in place of, the laterally extending portion (FIG. 1 at 130) of the base 104. In embodiments, a latch and catch assembly for maintaining the disc 108 in the stowed state may include a latch plate 142 mounted to the tab 120, a holder 144 mounted to the base 104, and a catch 146 mounted to the holder 144.

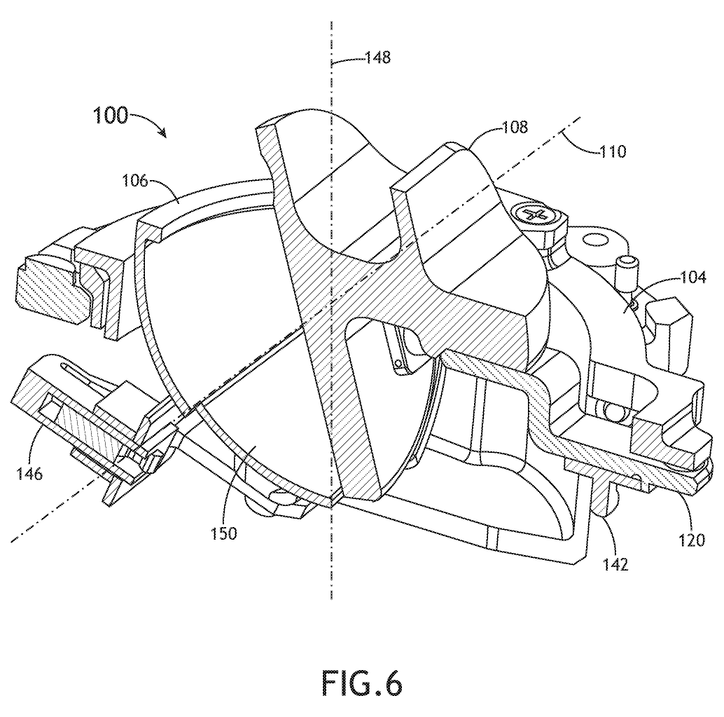

FIG. 6 depicts a cross section of the PED holder 100 in the deployed state. When fully deployed as shown, the disc 108 is rotated to a position such that the tab 120 carried by the disc 108 interfaces with the base 104 to limit further rotation of the disc 108 in the deployment direction. When in the deployed state, the disc 108 is free to rotate about the vertical axis 148 to adjust the disc 108 to change the viewing angle of the held PED. When in the deployed state, the latch plate 142 is disengaged from the catch 146. In embodiments, a closeout 150 may be used to cover the space formed between the bezel 106 and the disc 108 when the disc 108 is in the deployed state to prevent debris and spillage from migrating past the PED holder 100, as well as cover a possible pinch point.

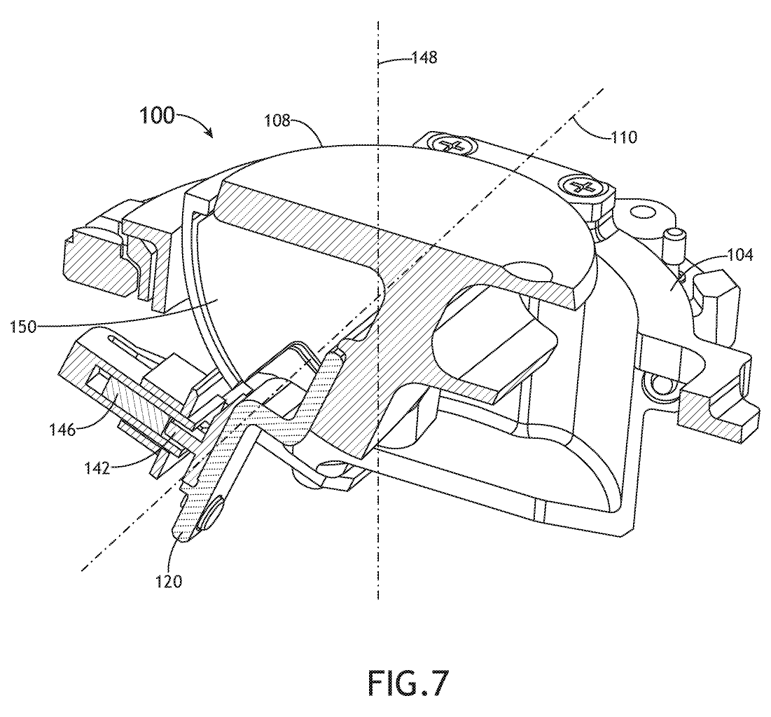

FIG. 7 depicts a cross section of the PED holder 100 in the stowed state. When fully stowed as shown, the disc 108 is rotated to a position such that the tab 120, which rotates with the disc 108, carries the latch plate 142 into engagement with the catch 146 to maintain the disc 108 in the stowed state. In embodiments, catch 146 may provide a comparatively weak retention force easily overcome by depressing the disc 108 at the location of the depression 126. Once free of the catch 146, the disc 108 may continue to be rotated by hand toward the deployed state. In embodiments, the PED holder 100 may further include, or be compatible for use with, mechanical actuators and/or charging devices. In embodiments, one or more position sensors may be used to confirm the status of the disc 108 for TTOL compliance.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A portable electronic device (PED) holder, comprising:
a rotation limiter mountable to a support surface;
a base rotatably mounted in the rotation limiter, the base rotatable about a vertical axis;
a bezel mounted in the base; and
a disc rotatably mounted in the base, the disc rotatable about a horizontal axis, and the disc having a first side that is substantially planar and a second side including a PED holding feature;
wherein the disc is configured to rotate between a stowed state in which the first side of the disc is positioned atop the PED holder, and a deployed state in which the second side of the disc is positioned atop the PED holder.

2. The PED holder of claim 1, further comprising:
a tab mounted to the disc;
a latch mounted to the tab; and
a catch mounted to the base;
wherein the tab is configured to interface with the base to maintain the disc in the deployed state, and the latch is configured to interface with the catch to maintain the disc in the stowed state.

3. The PED holder of claim 1, wherein the base has an opening through a side and bottom of the base, and the tab travels within the opening as the disc rotates between the stowed and deployed states of the disc.

4. The PED holder of claim 1, wherein the disc is rotatably mounted to the base by a pair of hinge clamp and friction hinge subassemblies.

5. The PED holder of claim 1, wherein:
the rotation limiter has a circumferential opening;
the base has a laterally extending portion disposed in the circumferential opening; and
the base interfaces with the rotation limiter to constrain rotational motion of the base.

6. The PED holder of claim 1, wherein the PED holding feature is a groove formed between two upstanding walls.

7. The PED holder of claim 1, further comprising at least one nylon spacer disposed at the interface between the base and the rotation limiter.

8. The PED holder of claim 1, further comprising a closeout configured to cover an opening formed between the disc and the bezel when the disc is in the deployed state.

9. A portable electronic device (PED) holder, comprising:
a round rotation limiter mountable to a support surface;
a round base rotatably mounted in the rotation limiter, the round base rotatable about a vertical axis; and
a round disc rotatably mounted in the round base, the round disc rotatable about a horizontal axis, and the round disc having a first side that is substantially planar and a second side including a PED holding feature;
wherein the round disc is configured to rotate between a stowed state in which the first side of the round disc is positioned atop the PED holder, and a deployed state in which the second side of the round disc is positioned atop the PED holder.

10. The PED holder of claim 9, further comprising:
an elongated tab mounted to the round disc;
a latch mounted to one end of the elongated tab; and
a catch mounted to the round base;
wherein the elongated tab is configured to interface with the round base to maintain the round disc in the deployed state, and the latch is configured to interface with the catch to maintain the round disc in the stowed state.

11. The PED holder of claim 9, wherein the round base has an opening through a side and bottom of the round base, and the elongated tab travels within the opening as the round disc rotates between the stowed and deployed states of the round disc.

12. The PED holder of claim 9, wherein the round disc is rotatably mounted to the round base by a pair of diametrically opposed hinge clamp and friction hinge subassemblies.

13. The PED holder of claim 9, wherein:
the round rotation limiter has a circumferential opening;
the round base has a laterally extending portion disposed in the circumferential opening; and
the round base interfaces with the round rotation limiter to constrain rotational motion of the round base.

14. The PED holder of claim 9, wherein the PED holding feature is a groove formed between two upstanding parallel walls.

15. The PED holder of claim 9, further comprising at least one nylon spacer disposed at the interface between the round base and the round rotation limiter.

16. The PED holder of claim 9, further comprising a closeout moveable with the round disc and configured to cover an opening formed between the round disc and the round base when the round disc is in the deployed state.

17. An assembly, comprising:
a support surface having a through opening; and
a portable electronic device (PED) holder disposed in the through opening and mounted to the support surface, the PED holder comprising:
a rotation limiter mountable to the support surface;
a base rotatably mounted in the rotation limiter, the base rotatable about a vertical axis;
a bezel mounted in the base; and
a disc rotatably mounted in the base, the disc rotatable about a horizontal axis, and the disc having a first side that is substantially planar and a second side including a PED holding feature;
wherein the disc is configured to rotate between a stowed state in which the first side of the disc is positioned atop the PED holder substantially flush with the support surface, and a deployed state in which the second side of the disc is positioned atop the PED holder and extends above the support surface.

18. The assembly of claim 17, further comprising:
a tab mounted to the disc;
a latch mounted to the tab; and
a catch mounted to the base;
wherein the tab is configured to interface with the base to maintain the disc in the deployed state, and the latch is configured to interface with the catch to maintain the disc in the stowed state.

19. The assembly of claim 17, wherein the disc is rotatably mounted to the base by a pair of diametrically opposed hinge clamp and friction hinge subassemblies.

20. The PED holder of claim 17, wherein:
the rotation limiter has a circumferential opening;
the base has a laterally extending portion disposed in the circumferential opening; and
the base interfaces with the rotation limiter to constrain rotational motion of the base.
